(19) United States
(12) Patent Application Publication
(10) Pub. No.: US 2026/0353144 A1
(43) Pub. Date: Nov. 5, 2026

(54) COLLISION RULES FOR MEASUREMENT GAPS

(71) Applicant: QUALCOMM Incorporated, San Diego, CA (US)

(72) Inventors: Yiqing CAO, Beijing (CN); Chu-Hsiang HUANG, San Diego, CA (US); Bin HAN, Beijing (CN)

(21) Appl. No.: 19/482,488

(22) PCT Filed: Jul. 4, 2023
(86) PCT No.: PCT/CN2023/105646

§ 371 Date: Nov. 7, 2025

(51) Int. Cl. H04W 24/10; H04L 5/00

(52) U.S. Cl. CPC H04W 24/10; H04L 5/0094

(57) ABSTRACT

Methods, systems, and devices for wireless communication are described. The method may include a user equipment (UE) transmitting first signaling indicating a capability of the UE to perform channel quality measurements on one or more reception frequency bands during a switching period that defines a duration for the UE to switch from transmitting using a first transmission frequency band to transmitting using a second transmission frequency band. Further, the method may include the UE receiving, based on the first signaling, an uplink grant scheduling the UE to transmit first uplink signaling using the first transmission frequency band and transmit second uplink signaling using the second transmission frequency band and performing, based on the uplink grant, the channel quality measurements on the one or more reception frequency bands.

### CROSS REFERENCE

The present Application for Patent is a 371 national phase filing of International Patent Application No. PCT/CN2023/105646 by CAO et al., entitled “COLLISION RULES FOR MEASUREMENT GAPS,” filed Jul. 4, 2023, assigned to the assignee hereof, and expressly incorporated by reference herein.

### FIELD OF TECHNOLOGY

The following relates to wireless communication, including collision rules for measurement gaps.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, a UE may perform measurements on downlink signals received using one or more target reception bands to determine channel quality metrics of the one or more target reception bands. The UE may perform the measurements during a measurement gap and during this measurement gap, the UE may be unable to receive or transmit on serving bands.

### SUMMARY

The described techniques relate to improved methods, systems, devices, and apparatuses that support collision rules for measurement gaps. For example, the described techniques provide for a user equipment (UE) or a network entity avoiding conflict between measurement gaps and transmission band switching periods when the UE is scheduled to transmit consecutive uplink signaling using different transmission bands. In some examples, the network entity may receive first signaling from the UE that indicates capability information associated with the UE. The capability information may indicate a capability of the UE to perform channel quality measurements during a switching period that defines a duration for the UE to switching from transmitting during a first transmission frequency band to transmitting using a second transmission frequency band. Upon receiving the capability information, the network entity may transmit an uplink grant scheduling the UE to transmit first uplink signaling using the first transmission frequency band followed by second uplink signaling using the second transmission frequency band. Based on the uplink grant, the UE may perform the channel quality measurement on the one or more reception frequency bands.

### BRIEF DESCRIPTION OF THE DRAWINGS

FIGS. 1 and 2 show examples of a wireless communications system that supports collision rules for measurement gaps in accordance with one or more aspects of the present disclosure.

FIGS. 3A, 3B, 4A, 4B, and 5 show examples of a switching scheme that supports collision rules for measurement gaps in accordance with one or more aspects of the present disclosure.

FIG. 6 shows an example of a process flow that supports collision rules for measurement gaps in accordance with one or more aspects of the present disclosure.

FIGS. 7 and 8 show block diagrams of devices that support collision rules for measurement gaps in accordance with one or more aspects of the present disclosure.

FIG. 9 shows a block diagram of a communications manager that supports collision rules for measurement gaps in accordance with one or more aspects of the present disclosure.

FIG. 10 shows a diagram of a system including a device that supports collision rules for measurement gaps in accordance with one or more aspects of the present disclosure.

FIGS. 11 and 12 show block diagrams of devices that support collision rules for measurement gaps in accordance with one or more aspects of the present disclosure.

FIG. 13 shows a block diagram of a communications manager that supports collision rules for measurement gaps in accordance with one or more aspects of the present disclosure.

FIG. 14 shows a diagram of a system including a device that supports collision rules for measurement gaps in accordance with one or more aspects of the present disclosure.

FIGS. 15 through 20 show flowcharts illustrating methods that support collision rules for measurement gaps in accordance with one or more aspects of the present disclosure.

### DETAILED DESCRIPTION

In some examples, a user equipment (UE) may perform periodic or aperiodic measurements on downlink signals to determine a channel quality of a target frequency band. The UE may perform the measurements during measurement gaps and during the measurement gap, the UE may not transmit or receive on a serving band. Further, in some examples, a network entity may schedule the UE to transmit consecutive uplink transmissions. A first uplink transmission may occur prior to the measurement gap and a second uplink transmission may occur after the measurement gap. However, in some examples, the UE may utilize different uplink transmission bands to transmit the consecutive uplink transmissions. For example, the UE may transmit the first uplink transmission using a first uplink transmission band and the second uplink transmission using a second uplink transmission band. In such case, the UE may create a switching gap between the consecutive uplink transmission resulting in an overlap between the switching gap and the measurement gap. Currently, there is no guidance on how to handle conflicts between measurement gaps and skipping gaps and in the event of such collision, the UE may experience an error.

As described herein, a set of collision rules may be defined for a UE or a network entity to handle conflicts between switching gaps and the measurement gaps to avoid errors at the UE. In some examples, the UE may transmit capability information indicating whether the UE may perform channel quality measurements during a switching gap associated with switching from a first uplink transmission band to a second uplink transmission band. Upon receiving the capability information, the network entity may transmit an uplink grant scheduling a first uplink transmission using the first uplink transmission band and a second uplink transmission using the second uplink transmission band. If the UE is unable to perform measurements during the switching gap, the network entity may schedule the first uplink transmission and the second uplink transmission such there is a gap between the switching period and the measurement gap. In another example, the UE may drop at least a portion of the first uplink transmission or the second uplink transmission and perform the switching during the portion. Using such methods may allow the UE or the network entity to resolve conflict between measurement gaps and switching gaps.

Aspects of the disclosure are initially described in the context of wireless communications systems. Additional aspects are described in the context of switching schemes and a process flow. Aspects of the disclosure are further illustrated by and described with reference to apparatus diagrams, system diagrams, and flowcharts that relate to collision rules for measurement gaps.

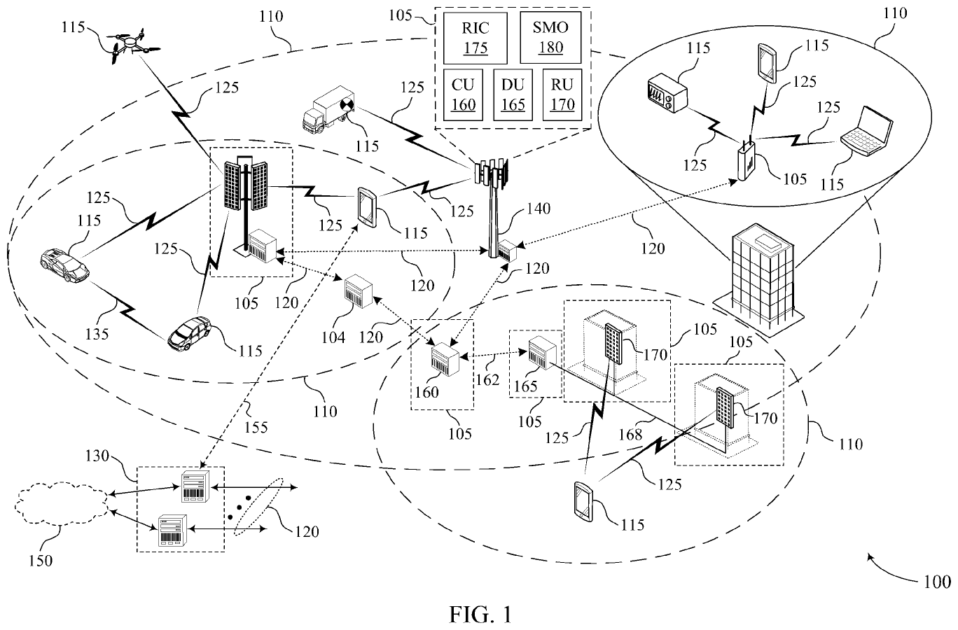

FIG. 1 shows an example of a wireless communications system 100 that supports collision rules for measurement gaps in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support collision rules for measurement gaps as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, a set of collision rules may be defined such that a UE 115 may avoid conflict between measurement gaps and transmission band switching periods when the UE 115 is scheduled to transmit consecutive uplink signaling using different transmission bands. In some examples, the network entity 105 may receive first signaling from the UE 115 that indicates capability information associated with the UE 115. The capability information may indicate a capability of the UE 115 to perform channel quality measurements during a switching period that defines a duration for the UE 115 to switching from transmitting during a first transmission frequency band to transmitting using a second transmission frequency band. Upon receiving the capability information, the network entity 105 may transmit an uplink grant scheduling the UE 115 to transmit first uplink signaling using the first transmission frequency band followed by second uplink signaling using the second transmission frequency band. Based on the uplink grant, the UE 115 may perform the channel quality measurement on the one or more reception frequency bands.

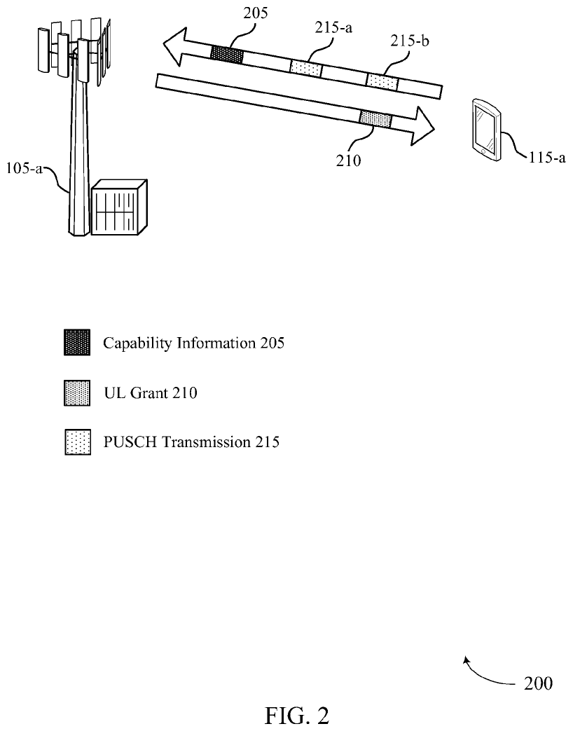

FIG. 2 shows an example of a wireless communications system 200 that supports collision rules for measurement gaps in accordance with one or more aspects of the present disclosure. In some examples, the wireless communications system 200 may implement aspects of a wireless communications system 100. For example, the wireless communications system 200 may include a UE 115-a which may be an example of a UE 115 as described with reference to FIG. 1. Additionally, the wireless communications system 200 may include a network entity 105-a which may be an example of a network entity 105 as described with reference to FIG. 1.

In some examples, the UE 115-a may be configured with measurement gaps. Measurement gaps may be described as opportunities given to the UE 115-a to perform measurements on downlink signals of target frequency bands. Using the measurements, the UE 115-a may determine a channel quality of each of the target frequency bands which may influence future scheduling. In some examples, the UE 115-a may be unable to perform the measurements while transmitting or receiving (e.g., using a serving frequency band). As such, the measurement gaps may be configured such that they do not coincide with scheduled transmissions or receptions. As one example, if the network entity 105-a schedules the UE 115-a to transmit a first uplink message followed by a second uplink message, the measurement gap may fall between transmission of the first uplink message and transmission of the second uplink message, but may not overlap with either of the transmission of the first uplink message or the transmission of the second uplink message.

In some examples, the UE 115-a may switch between different frequency bands when transmitting consecutive uplink messages. For example, the UE 115-a may utilize a first frequency band to transmit a first uplink message and may utilize a second frequency band to transmit a second uplink message. The UE 115-a may switch between a minimum of two frequency bands and a maximum of four frequency bands for uplink transmissions. To switch from one frequency band to another frequency band, the UE 115-a may undergo RF tuning. During the RF tuning, the UE 115-a may adapt RF components of the transmission chain such that transmissions using the target frequency band may be possible.

A switching gap may specify a duration during which the UE 115-a performs the RF tuning. However, if a measurement gap is configured between two consecutive uplink transmissions and the UE 115-a is scheduled to transmit the two consecutive uplink transmissions using two different frequency bands, a duration between the measurement gap and either one of the uplink transmissions may not be enough to include the switching gap and as such, the switching gap may overlap with the measurement gaps. In some examples, the UE 115-a may be unable to support RF tuning during the measurement gap and there is no clear guidance or rules regarding how the UE 115-a may handle conflicts between the measurement gap and the switching gap.

As described herein, one or more rules may be put in place for a UE 115-a or a network entity 105-a to handle collisions between measurement gaps and switching gaps. In one example, the UE 115-a may transmit capability information 205 to the network entity 105-a. The capability information 205 may indicate a capability of the UE 115-a to perform channel quality measurements (e.g., during a measurement gap) during a switching gap that defines a duration for the UE 115-a to switch from a first frequency band to a second frequency band. In some cases, a reception chain and a transmission chain of the UE 115-a may not share RF components. As such, the capability information 205 may indicate an ability of the UE 115-a to perform channel quality measurements during the switching gap and in response to the capability information 205, the network entity 105-a may schedule (e.g., using an uplink grant 210) the UE 115-a to transmit consecutive uplink transmissions using different frequency bands as usual (e.g., without taking into account the measurement gap).

Alternatively, the reception chain and the transmission chain of the UE 115-a may share RF components. As such, the capability information 205 may indicate an inability of the UE 115-a to perform channel quality measurements during the switching gap. In such case, as one option, the network entity 105-a may guarantee that the UE 115-a will not encounter a conflict between the measurement gap and the switching gap. For example, upon receiving the capability information 205, the network entity 105-a may transmit an uplink grant 210 to the UE 115-a scheduling the UE 115-a to transmit a PUSCH transmission 215-a using a first frequency band followed by a PUSCH transmission 215-b using a second frequency band. Between the PUSCH transmission 215-a and the PUSCH transmission 215-b may be a measurement gap. The network entity 105-a may schedule the PUSCH transmissions 215 such that there is a duration between the switching gap (to switch from the first frequency band to the second frequency band) and the measurement gap. By scheduling the UE 115-a in such a way, the network entity 105-a may ensure that the measurement gap and the switching gap do not overlap and cause a collision at the UE 115-a.

As another option, the UE 115-a may prioritize the measurement gap over the switching period in the event that the UE 115-a is incapable of handling simultaneous channel quality measurement and transmission switching. For example, the UE 115-a may receive an uplink grant 210 that schedules the UE 115-a to transmit a PUSCH transmission 215-a using a first frequency band followed by a PUSCH transmission 215-b using a second frequency bands. Between the PUSCH transmission 215-a and the PUSCH transmission 215-b there may be a measurement gap. As opposed to performing switching (to switch from the first frequency band to the second frequency band) during the measurement gap, the UE 115-a may perform switching during the PUSCH transmission 215-a or the PUSCH transmission 215-b. In other words, a portion of the PUSCH transmission 215-a or the PUSCH transmission 215-b may be dropped in order to perform switching. Using the methods as described herein may allow the UE 115-a to avoid collisions between measurement gaps and switching gaps which may mitigate errors (e.g., errors in InterOperability Device Testing (IoDT)) resulting from the collisions.

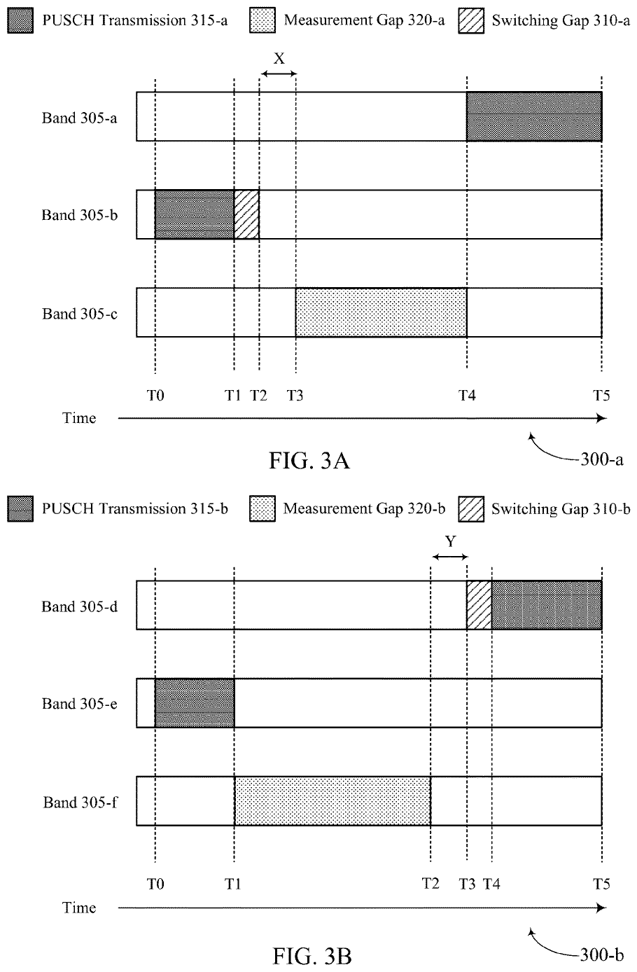

FIGS. 3A and 3B shows an example of a switching scheme 300 (e.g., a switching scheme 300-a and a switching scheme 300-b ) that supports collision rules for measurement gaps in accordance with one or more aspects of the present disclosure. In some examples, the switching schemes 300 may implement aspects of a wireless communications system 100 and a wireless communications system 200. For example, the switching schemes 300 may be implemented by a network entity 105 or a UE 115 as described with reference to FIGS. 1 and 2.

As described with reference to FIG. 2, a network entity may schedule a UE to transmit consecutive uplink messages using different frequency bands in such a way as to avoid collisions between measurement gaps 320 and switching gaps 310. In the example of FIG. 3A, the UE may receive an UL grant scheduling the UE to transmit a first PUSCH transmission 315-a during a first set of symbols (e.g., from T0 to T1) using a band 305-b and a second PUSCH transmission 315-a during a second set of symbols using a band 305-a (e.g., from T4 to T5).

As shown in FIG. 3A, between the first set of symbols and the second set of symbols, the UE may perform channel quality measurements and as such, there may be a measurement gap 320-a on the serving band or band 305-c (e.g., from T3 to T4).

Additionally, between the first set of symbols and the second set of symbols and prior to the measurement gap 320-a, the UE may perform RF tuning to switch from the band 305-b to the band 305-a and as such, there may be a switching gap 310-a on the band 305-b (e.g., from T1 to T2).

To ensure that the measurement gap 320-a does not overlap with the switching gap 310-a and to provide the UE sufficient time to prepare the measurement gap 320-a, the network entity may schedule a gap between the switching gap and the measurement gap. The gap may span from T2 to T3 and a value of the gap may be equal to X. In some examples, the value of X may be pre-configured at the network entity. In another example, the UE may determine the value of X based on its capability and report the value of X to the network entity. The value of X may be expressed in microseconds or a quantity of symbols.

Thus, in FIG. 3A, upon receiving the UL grant, the UE may transmit the first PUSCH transmission 315-a using band 305-b from T0 to T1. From T1 to T2, the UE may perform RF tuning and switch from the band 305-b to the band 305-a. Further, the UE may prepare the measurement gap 320-a during the gap which spans T2 to T3 and perform channel quality measurements during the measurement gap 320-a from T3 to T4. Further, from T4 to T5, the UE may transmit the second PUSCH transmission 315-a using the band 305-a .

In the example of FIG. 3B, the UE may receive an UL grant scheduling the UE to transmit a first PUSCH transmission 315-b during a first set of symbols (e.g., from T0 to T1) using a band 305-e and a second PUSCH transmission 315-b during a second set of symbols using a band 305-d (e.g., from T4 to T5).

As shown in FIG. 3B, between the first set of symbols and the second set of symbols, the UE may perform channel quality measurements and as such, there may be a measurement gap 320-b on the serving band or band 305-f (e.g., from T1 to T2).

Additionally, between the first set of symbols and the second set of symbols and after the measurement gap 320-b, the UE may perform RF tuning to switch from the band 305-e to the band 305-d and as such, there may be a switching gap 310-b on the band 305-d (e.g., from T3 to T4).

To ensure that the measurement gap 320-b does not overlap with the switching gap 310-b and to provide the UE sufficient time to prepare for the switching gap 310-b, the network entity may schedule a gap between the switching gap 310-b and the measurement gap 320-b. The gap may span from T2 to T3 and a value of the gap may be equal to Y. In some examples, the value of Y may be pre-configured at the network entity. In another example, the UE may determine the value of Y based on its capability and report the value of Y to the network entity. The value of Y may be expressed in microseconds or a quantity of symbols.

Thus, in FIG. 3B, upon receiving the UL grant, the UE may transmit the first PUSCH transmission 315-b using band 305-e from T0 to T1. From T1 to T2, the UE may perform channel quality measurements during the measurement gap 320-b. Further, the UE may prepare the switching gap 310-b during the gap which spans T2 to T3 and from T3 to T4, the UE may perform RF tuning to switch from the band 305-e to the band 305-d. Further, from T4 to T5, the UE may transmit the second PUSCH transmission 315-b using the band 305-d.

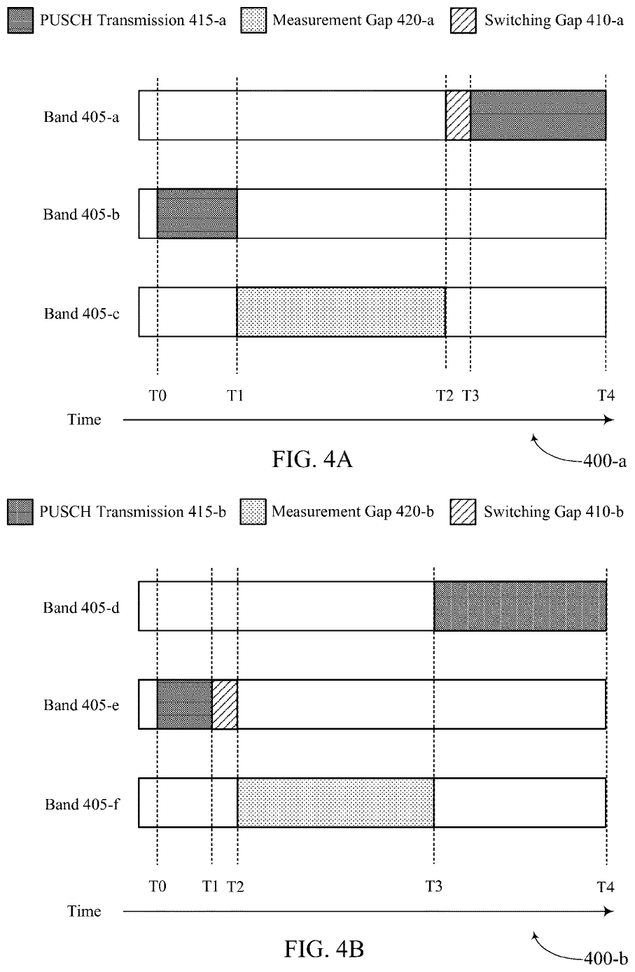

FIGS. 4A and 4B shows an example of a switching scheme 400 (e.g., the switching scheme 400-a and the switching scheme 400-b ) that supports collision rules for measurement gaps in accordance with one or more aspects of the present disclosure. In some examples, the switching schemes 400 may implement aspects of a wireless communications system 100 and a wireless communications system 200. For example, the switching schemes 400 may be implemented by a network entity 105 or a UE 115 as described with reference to FIGS. 1 and 2.

As described with reference to FIG. 2, the UE may drop at least a portion of an uplink message to perform RF tuning such that a switching gap 410 used by the UE to perform the RF tuning does not overlap with a measurement gap 420 used by the UE to perform channel quality measurements. In the example of FIG. 4A, the UE may receive an UL grant from a network entity scheduling the UE to transmit a first PUSCH transmission 415-a during a first set of symbols (e.g., from T0 to T1) using a band 405-b and a second PUSCH transmission 415-a during a second set of symbols (e.g., from T2 to T4) using the band 405-a.

As shown in FIG. 4A, between the first set of symbols and the second set of symbols, the UE may perform channel quality measurements and as such, there may be a measurement gap 420-a on the serving band or band 405-c (e.g., from T1 to T2). To switch from the band 405-b to the band 405-a , the UE may perform RF tuning.

However, as shown in FIG. 4A, there may not be a sufficient gap of time between the first set of symbols and the measurement gap 420-a or the second set of symbols and the measurement gap 420-a for the UE to perform the RF tuning. As such, the UE may prioritize the measurement gap 420-a and perform the RF tuning during at least a portion of the second PUSCH transmission 415-a. That is, a subset of the second set of symbols (e.g., from T2 to T3) may include the switching gap 410-a .

Thus, in the example of FIG. 4A, upon receiving the UL grant, the UE may transmit the first PUSCH transmission 415-a using band 405-b from T0 to T1. From T1 to T2, the UE may perform channel quality measurements during the measurement gap 420-a . Further, the UE may perform RF tuning and switch from the band 405-b to the band 405-a from T2 to T3 and during a first portion of the second PUSCH transmission 415-a . From T3 to T4, the UE may perform a second portion of the second PUSCH transmission 415-a using the band 405-a. The first portion of the PUSCH transmission may be dropped such that the UE may perform switching from T2 to T3.

In the example of FIG. 4B, the UE may receive an UL grant from a network entity scheduling the UE to transmit a first PUSCH transmission 415-b during a first set of symbols (e.g., from T0 to T2) using a band 405-e and a second PUSCH transmission 415-b during a second set of symbols (e.g., from T3 to T4) using the band 405-d.

As shown in FIG. 4B, between the first set of symbols and the second set of symbols, the UE may perform channel quality measurements and as such, there may be a measurement gap 420-b on the serving band or band 405-f (e.g., from T2 to T3). To switch from the band 405-e to the band 405-d, the UE may perform RF tuning.

However, as shown in FIG. 4B, there may not be a sufficient gap of time between the first set of symbols and the measurement gap 420-b or the second set of symbols and the measurement gap 420-b for the UE to perform the RF tuning. As such, the UE may prioritize the measurement gap 420-b and perform the RF tuning during at least a portion of the first PUSCH transmission 415-b. That is, a subset of the second set of symbols (e.g., from T1 to T2) may include the switching gap 410-b.

Thus, in the example of FIG. 4B, upon receiving the UL grant, the UE may transmit a first portion of the first PUSCH transmission 415-b using band 405-e from T0 to T1. From T1 to T2 and during a second portion of the first PUSCH transmission 415-b, the UE may perform RF tuning and switch from the band 405-e to the band 405-d. The second portion of the first PUSCH transmission 415-b may be dropped such that the UE may perform switching from T1 to T2. Further, from T2 to T3, the UE may perform channel quality measurements during the measurement gap 420-b. Lastly, from T3 to T4, the UE may transmit the second PUSCH transmission 415-b using the band 405-d.

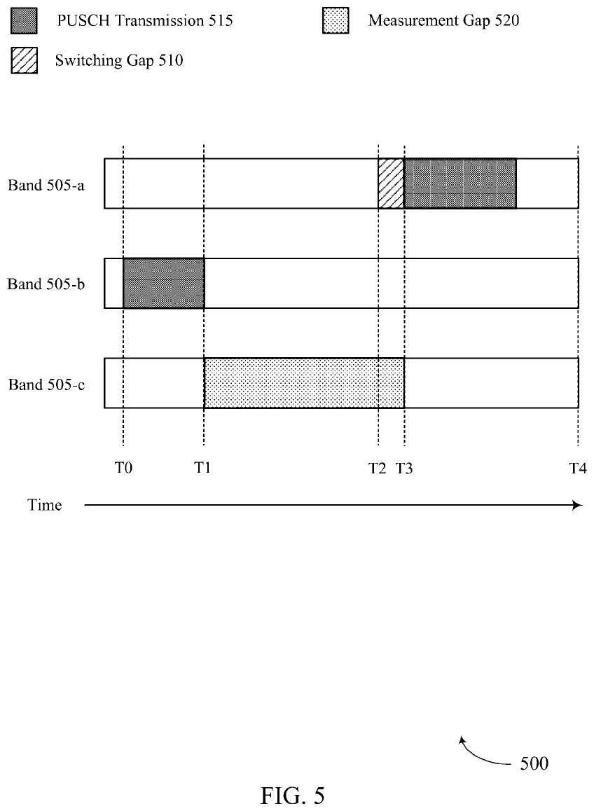

FIG. 5 shows an example of a switching scheme 500 that supports collision rules for measurement gaps in accordance with one or more aspects of the present disclosure. In some examples, the switching scheme 500 may implement aspects of a wireless communications system 100 and a wireless communications system 200. For example, the switching scheme 500 may be implemented by a network entity 105 or a UE 115 as described with reference to FIGS. 1 and 2.

As described with reference to FIG. 2, in some examples, a UE may be capable of performing RF tuning while performing channel quality measurements. In the example of FIG. 5, the UE may receive an uplink grant from a network entity scheduling the UE to transmit a first PUSCH transmission 515 using a first set of symbols (e.g., T0 to T1) and a second PUSCH transmission 515 using a second set of symbols (e.g., T3 to T4).

As shown in FIG. 5, between the first set of symbols and the second set of symbols, the UE may perform channel quality measurement and as such, there may be a measurement gap 520 in the serving band or a band 505-a (e.g., from T1 to T3). To switch from the band 505-b to the band 505-a, the UE may perform RF tuning.

However, as shown in FIG. 5, there may not be a sufficient gap of time between the first set of symbols and the measurement gap 520 or the second set of symbols and the measurement gap 520 for the UE to perform the RF tuning. As such, the UE may and perform the RF tuning during at least a portion of the measurement gap 520. That is, a subset of symbols allocated for the measurement gap 520 may include the switching gap 510.

Thus, in the example of FIG. 5, upon receiving the UL grant, the UE may transmit the first PUSCH transmission 515 using band 505-b from T0 to T1. From Tl to T3, the UE may perform channel quality measurements during the measurement gap 520. Further, during a portion of the measurement gap 520 and from T2 to T3, the UE may perform RF tuning and switch from the band 505-b to the band 505-a. Lastly, from T3 to T4, the UE may transmit the second PUSCH transmission 515 using the band 505-a.

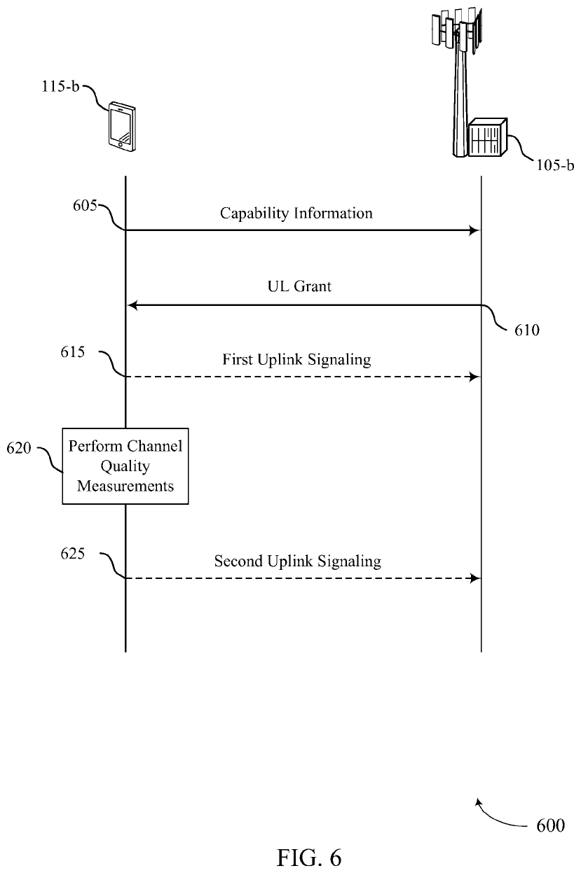

FIG. 6 shows an example of a process flow 600 that supports collision rules for measurement gaps in accordance with one or more aspects of the present disclosure. In some examples, the process flow 600 may implement, or be implemented by, aspects of a wireless communications system 100 and a wireless communications system 200.

For example, the process flow 600 may be performed by a UE 115-b and a network entity 105-b which may be example of a UE 115 and a network entity 105 as described with reference to FIGS. 1 and 2, respectively. Alternative examples of the following may be implemented, where some steps are performed in a different order then described or are not performed at all. In some cases, steps may include additional features not mentioned below, or further steps may be added.

At 605, the UE 115-b may transmit first signaling indicating a capability of the UE 115-b to perform channel quality measurements on one or more reception frequency bands during a switching period that defines a duration for the UE to switch from transmitting using a first transmission band to transmitting using a second transmission frequency band.

At 610, the UE 115-b, based on the first signaling indicating the capability, may receive an uplink grant from the network entity 105-b scheduling the UE 115-b to transmit first uplink signaling using the first transmission frequency band and transmit second uplink signaling using the second transmission frequency band. In some examples, the uplink grant may indicate a first set of symbols allocated for transmission of the first uplink signaling and a second set of symbols allocated for transmission of the second uplink signaling. In some examples, the first set of symbols may be associated with an earlier time slot than a time slot associated with the second set of symbols.

In one example, the capability may indicate an inability of the UE 115-b to perform channel quality measurements during the switching period. In such case, the network entity 105-b may schedule the UE 115-b in such a way as to ensure that the switching period and a measurement gap for performing the channel quality measurement do not overlap. As one example of this, at 615, the UE 115-b may transmit the first uplink signaling using the first set of symbols and then, at 620, the UE 115-b may perform channel quality measurements a first gap period after the switching period which may occur after a last symbol of the first set of symbols. Further, at 625, the UE 115-b may transmit the second uplink signaling using the second set of symbols.

As another option, at 615, the UE 115-b may transmit the first uplink signaling using the first set of symbols and then, at 620, the UE 115-b may perform channel quality measurements. Further, at 625, the UE 115-b may transmit the second uplink message after the switching period that occurs a second gap period after performing the channel quality measurements. In some examples, prior to transmitting the first signaling indicating the capability, the UE 115-b may transmit second signaling to the network entity 105-b indicating one or more gap periods that may include one or both of the first gap period or the second gap period. In some examples, the one or more gap periods may be based on a capability of the UE 115-b.

Alternatively, if the UE 115-b does not have the ability to perform channel quality measurements during the switching period, the UE 115-b may prioritize the measurement gap for performing channel quality measurement over the switching period. As one example, at 615, the UE 115-b may transmit the first uplink signaling using the first set of symbols and then, at 620, the UE 115-b may perform channel quality measurements. After performing the channel quality measurements, the UE 115-b may switch from the first transmission frequency band to the second transmission frequency band during a switching period that spans a first subset of the second set of symbols and at 625, the UE 115-b may transmit the second uplink signaling using a second subset of second set of symbols.

As another example, at 615, the UE 115-b may transmit the first uplink signaling during a first subset of the first set of symbols and switch from the first transmission frequency band to the second transmission frequency band during a switching period that spans a second subset of the first set of symbols. After switching and at 620, the UE 115-b may perform channel quality measurements and at 625, the UE 115-b may transmit the second uplink signaling using the second set of symbols.

That is, the UE 115-b may drop at least a portion of the first uplink signaling or the second uplink signaling to perform switching during the switching period. In some examples, the UE 115-b will refrain from transmitting one or more of the first uplink signaling or the second uplink signaling completely in order to perform switching during the switching period.

Alternatively, the capability may indicate an ability of the UE 115-b to perform channel quality measurements during the switching period. In such case, at 615, the UE 115-b may transmit first uplink signaling using the first set of symbols and then, at 620, the UE 115-b may perform channel quality measurement during the measurement gap. Further, during at least a portion of the measurement gap, the UE 115-b may switch from the first transmission frequency band to the second transmission frequency band during the switching period. Further, at 625, the UE 115-b may transmit the second uplink signaling using the second set of symbols. Using such methods may allow the UE 115-b to handle potential conflicts between measurement gaps and switching periods which may mitigate error at the UE 115-b.

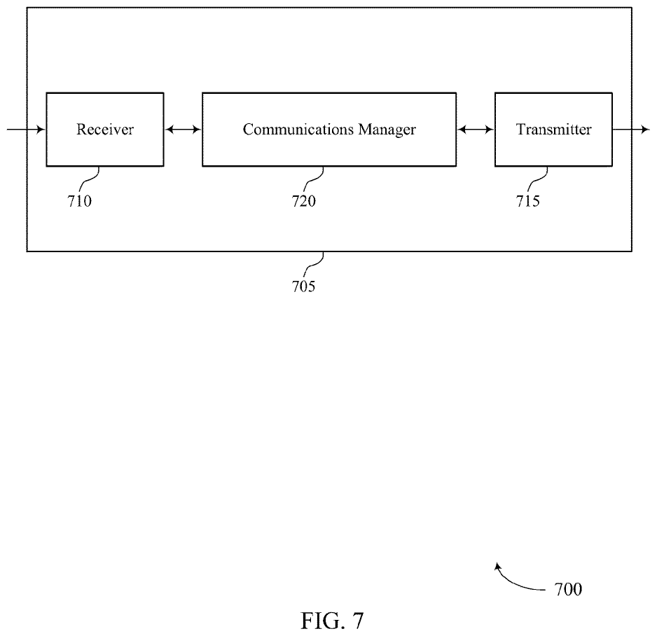

FIG. 7 shows a block diagram 700 of a device 705 that supports collision rules for measurement gaps in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to collision rules for measurement gaps). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to collision rules for measurement gaps). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of collision rules for measurement gaps as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting first signaling indicating a capability of the UE to perform channel quality measurements on one or more reception frequency bands during a switching period that defines a duration for the UE to switch from transmitting using a first transmission frequency band to transmitting using a second transmission frequency band. The communications manager 720 is capable of, configured to, or operable to support a means for receiving, based on the first signaling indicating the capability, an uplink grant scheduling the UE to transmit first uplink signaling using the first transmission frequency band and transmit second uplink signaling using the second transmission frequency band. The communications manager 720 is capable of, configured to, or operable to support a means for performing, based on the uplink grant, the channel quality measurements on the one or more reception frequency bands.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

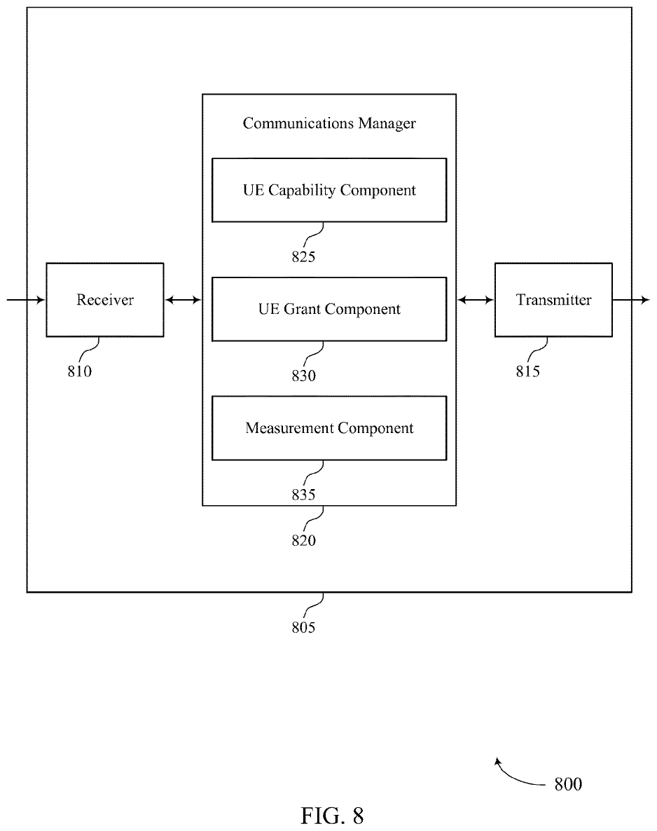

FIG. 8 shows a block diagram 800 of a device 805 that supports collision rules for measurement gaps in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to collision rules for measurement gaps). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to collision rules for measurement gaps). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of collision rules for measurement gaps as described herein. For example, the communications manager 820 may include a UE capability component 825, a UE grant component 830, a measurement component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The UE capability component 825 is capable of, configured to, or operable to support a means for transmitting first signaling indicating a capability of the UE to perform channel quality measurements on one or more reception frequency bands during a switching period that defines a duration for the UE to switch from transmitting using a first transmission frequency band to transmitting using a second transmission frequency band. The UE grant component 830 is capable of, configured to, or operable to support a means for receiving, based on the first signaling indicating the capability, an uplink grant scheduling the UE to transmit first uplink signaling using the first transmission frequency band and transmit second uplink signaling using the second transmission frequency band. The measurement component 835 is capable of, configured to, or operable to support a means for performing, based on the uplink grant, the channel quality measurements on the one or more reception frequency bands.

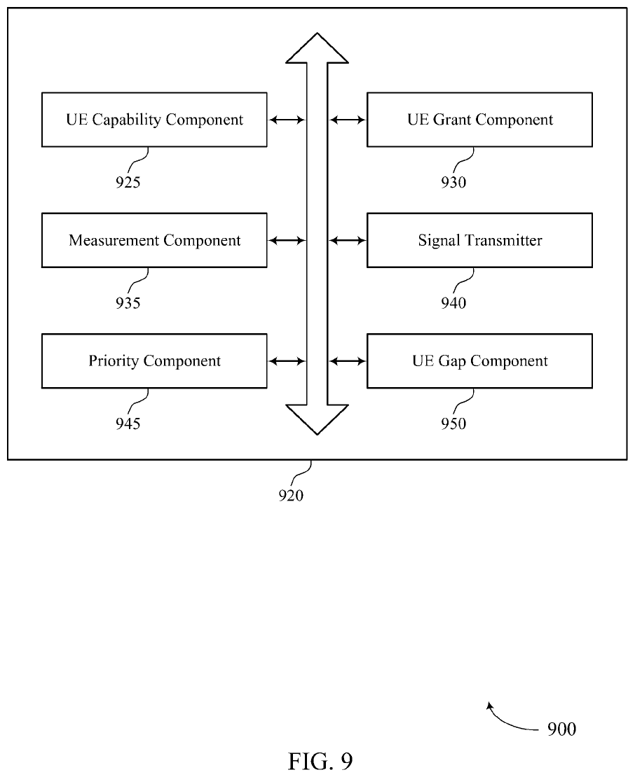

FIG. 9 shows a block diagram 900 of a communications manager 920 that supports collision rules for measurement gaps in accordance with one or more aspects of the present disclosure. The communications manager 920 may be an example of aspects of a communications manager 720, a communications manager 820, or both, as described herein. The communications manager 920, or various components thereof, may be an example of means for performing various aspects of collision rules for measurement gaps as described herein. For example, the communications manager 920 may include a UE capability component 925, a UE grant component 930, a measurement component 935, a signal transmitter 940, a priority component 945, a UE gap component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The UE capability component 925 is capable of, configured to, or operable to support a means for transmitting first signaling indicating a capability of the UE to perform channel quality measurements on one or more reception frequency bands during a switching period that defines a duration for the UE to switch from transmitting using a first transmission frequency band to transmitting using a second transmission frequency band. The UE grant component 930 is capable of, configured to, or operable to support a means for receiving, based on the first signaling indicating the capability, an uplink grant scheduling the UE to transmit first uplink signaling using the first transmission frequency band and transmit second uplink signaling using the second transmission frequency band. The measurement component 935 is capable of, configured to, or operable to support a means for performing, based on the uplink grant, the channel quality measurements on the one or more reception frequency bands.

In some examples, the uplink grant indicates a first set of symbols allocated for transmission of the first uplink signaling and a second set of symbols allocated for transmission of the second uplink signaling, the first set of symbols associated with an earlier time slot than a time slot associated with the second set of symbols.

In some examples, the signal transmitter 940 is capable of, configured to, or operable to support a means for transmitting, prior to performing the channel quality measurements, the first uplink signaling using the first transmission frequency band during the first set of symbols. In some examples, the signal transmitter 940 is capable of, configured to, or operable to support a means for transmitting, after performing the channel quality measurements and based on the capability indicating an inability of the UE to perform the channel quality measurements during the switching period, the second uplink signaling using the second transmission frequency band during a first subset of the second set of symbols, where the switching period includes a second subset of the second set of symbols.

In some examples, the signal transmitter 940 is capable of, configured to, or operable to support a means for transmitting, prior to performing the channel quality measurements, the first uplink signaling using the first transmission frequency band during a first subset of the first set of symbols based on the capability indicating an inability of the UE to perform the channel quality measurements during the switching period, where the switching period includes a second subset of the first set of symbols. In some examples, the signal transmitter 940 is capable of, configured to, or operable to support a means for transmitting, after performing the channel quality measurements, the second uplink signaling using the second transmission frequency band during the second set of symbols.

In some examples, the priority component 945 is capable of, configured to, or operable to support a means for refraining from transmitting one or both of the first uplink signaling or the second uplink signaling based on the capability indicating an inability of the UE to perform the channel quality measurements during the switching period, where the switching period includes at least a subset of the first set of symbols or the second set of symbols.

In some examples, to support performing the channel quality measurements, the measurement component 935 is capable of, configured to, or operable to support a means for performing the channel quality measurements a first gap period after the switching period based on the capability indicating an inability of the UE to perform the channel quality measurements during the switching period, where the switching period occurs after a last symbol of the first set of symbols.

In some examples, the UE gap component 950 is capable of, configured to, or operable to support a means for transmitting second signaling indicating a set of gap periods including the first gap period, where the uplink grant is based on the set of gap periods.

In some examples, the signal transmitter 940 is capable of, configured to, or operable to support a means for transmitting the second uplink signaling after the switching period based on the capability indicating an inability of the UE to perform the channel quality measurements during the switching period, where the switching period occurs a first gap period after performing the channel quality measurements.

In some examples, the UE gap component 950 is capable of, configured to, or operable to support a means for transmitting second signaling indicating one or more gap periods including the first gap period, where the uplink grant is based on the one or more gap periods.

In some examples, to support performing the channel quality measurements, the measurement component 935 is capable of, configured to, or operable to support a means for performing the channel quality measurements during at least a portion of the switching period based on the capability indicating an ability of the UE to perform the channel quality measurements during the switching period.

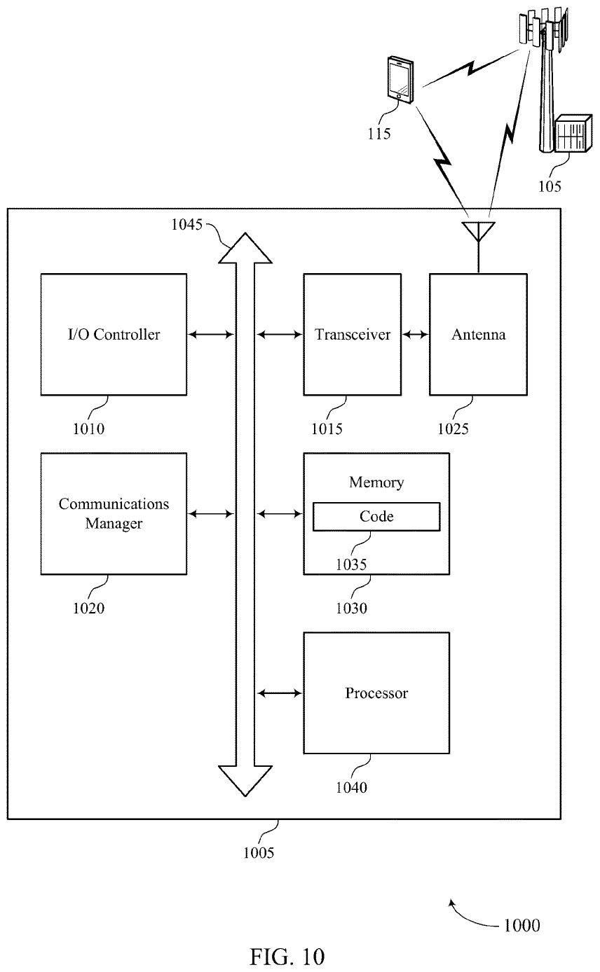

FIG. 10 shows a diagram of a system 1000 including a device 1005 that supports collision rules for measurement gaps in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions.

The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting collision rules for measurement gaps). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communications in accordance with examples as disclosed herein. For example, the communications manager 1020 is capable of, configured to, or operable to support a means for transmitting first signaling indicating a capability of the UE to perform channel quality measurements on one or more reception frequency bands during a switching period that defines a duration for the UE to switch from transmitting using a first transmission frequency band to transmitting using a second transmission frequency band. The communications manager 1020 is capable of, configured to, or operable to support a means for receiving, based on the first signaling indicating the capability, an uplink grant scheduling the UE to transmit first uplink signaling using the first transmission frequency band and transmit second uplink signaling using the second transmission frequency band. The communications manager 1020 is capable of, configured to, or operable to support a means for performing, based on the uplink grant, the channel quality measurements on the one or more reception frequency bands.

By including or configuring the communications manager 1020 in accordance with examples as described herein, the device 1005 may support techniques for improved communication reliability and more efficient utilization of communication resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of collision rules for measurement gaps as described herein, or the at least one processor 1040 and the at least one memory 1030 may be otherwise configured to, individually or collectively, perform or support such operations.

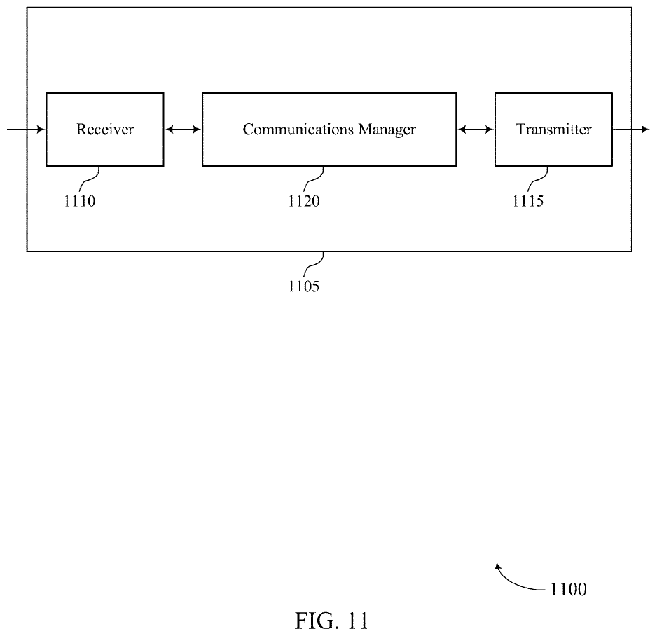

FIG. 11 shows a block diagram 1100 of a device 1105 that supports collision rules for measurement gaps in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas.

Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of collision rules for measurement gaps as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band. The communications manager 1120 is capable of, configured to, or operable to support a means for transmitting, based on the first signaling indicating the capability, an uplink grant scheduling the UE to transmit the first uplink signaling using the first transmission frequency band and transmit the second uplink signaling using the second transmission frequency band.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

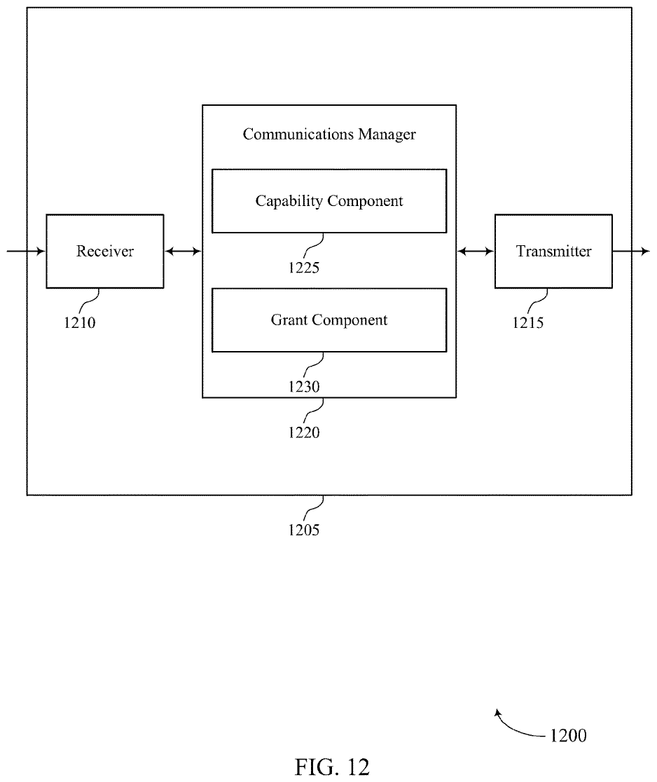

FIG. 12 shows a block diagram 1200 of a device 1205 that supports collision rules for measurement gaps in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of collision rules for measurement gaps as described herein. For example, the communications manager 1220 may include a capability component 1225 a grant component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The capability component 1225 is capable of, configured to, or operable to support a means for receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band. The grant component 1230 is capable of, configured to, or operable to support a means for transmitting, based on the first signaling indicating the capability, an uplink grant scheduling the UE to transmit the first uplink signaling using the first transmission frequency band and transmit the second uplink signaling using the second transmission frequency band.

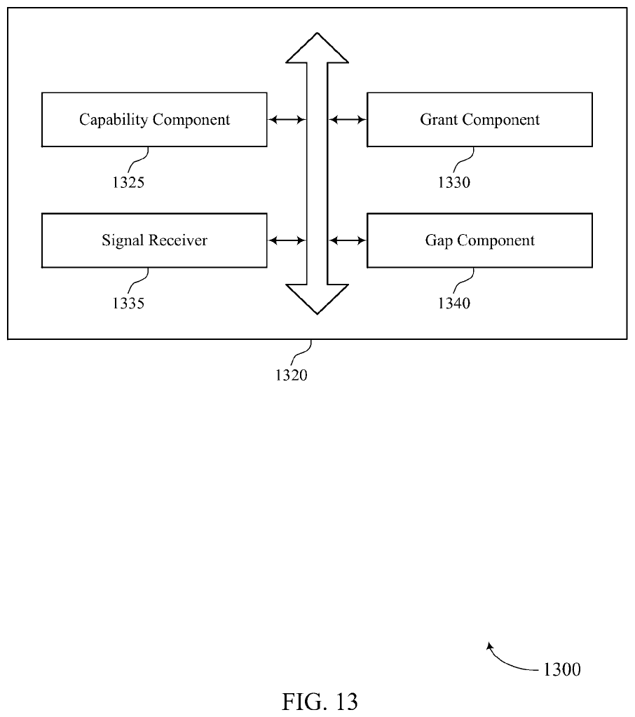

FIG. 13 shows a block diagram 1300 of a communications manager 1320 that supports collision rules for measurement gaps in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of collision rules for measurement gaps as described herein. For example, the communications manager 1320 may include a capability component 1325, a grant component 1330, a signal receiver 1335, a gap component 1340, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The capability component 1325 is capable of, configured to, or operable to support a means for receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band. The grant component 1330 is capable of, configured to, or operable to support a means for transmitting, based on the first signaling indicating the capability, an uplink grant scheduling the UE to transmit the first uplink signaling using the first transmission frequency band and transmit the second uplink signaling using the second transmission frequency band.

In some examples, the uplink grant indicates a first set of symbols allocated for transmission of the first uplink signaling and a second set of symbols allocated for transmission of the second uplink signaling, the first set of symbols associated with an earlier time slot than a time slot associated with the second set of symbols.

In some examples, the signal receiver 1335 is capable of, configured to, or operable to support a means for receiving, prior to a measurement gap associated with performing the channel quality measurements, the first uplink signaling using the first transmission frequency band during the first set of symbols. In some examples, the signal receiver 1335 is capable of, configured to, or operable to support a means for receiving, after the measurement gap and based on the capability indicating an inability of the UE to perform the channel quality measurements during the switching period, the second uplink signaling using the second transmission frequency band during a first subset of the second set of symbols, where the switching period includes a second subset of the second set of symbols.

In some examples, the signal receiver 1335 is capable of, configured to, or operable to support a means for receiving, prior to a measurement gap associated with performing the channel quality measurements, the first uplink signaling using the first transmission frequency band during a first subset of the first set of symbols based on the capability indicating an inability of the UE to perform the channel quality measurements during the switching period, where the switching period includes a second subset of the first set of symbols. In some examples, the signal receiver 1335 is capable of, configured to, or operable to support a means for receiving, after the measurement gap, the second uplink signaling using the second transmission frequency band during the second set of symbols.

In some examples, the uplink grant further indicates that a last symbol of the first set of symbols occurs prior to the switching period and a measurement gap associated with performing the channel quality measurements occurs a first gap period after the switching period.

In some examples, the gap component 1340 is capable of, configured to, or operable to support a means for receiving second signaling indicating a set of gap periods including the first gap period, where the uplink grant is based on the set of gap periods.

In some examples, the uplink grant further indicates that the switching period occurs prior to a first symbol of the second set of symbols and a measurement gap associated with performing the channel quality measurements ends a first gap period prior to the switching period.

In some examples, the gap component 1340 is capable of, configured to, or operable to support a means for receiving second signaling indicating a set of gap periods including the first gap period, where the uplink grant is based on the set of gap periods.

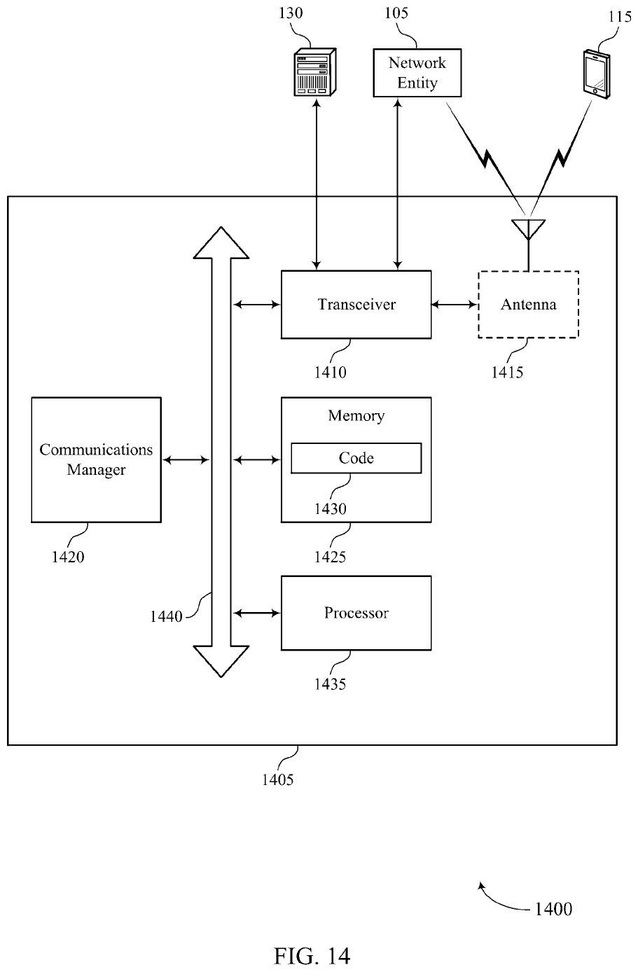

FIG. 14 shows a diagram of a system 1400 including a device 1405 that supports collision rules for measurement gaps in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435.

These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting collision rules for measurement gaps). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some implementations, the at least one processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the at least one processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band. The communications manager 1420 is capable of, configured to, or operable to support a means for transmitting, based on the first signaling indicating the capability, an uplink grant scheduling the UE to transmit the first uplink signaling using the first transmission frequency band and transmit the second uplink signaling using the second transmission frequency band.

By including or configuring the communications manager 1420 in accordance with examples as described herein, the device 1405 may support techniques for improved communication reliability and more efficient utilization of communication resources.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of collision rules for measurement gaps as described herein, or the at least one processor 1435 and the at least one memory 1425 may be otherwise configured to, individually or collectively, perform or support such operations.

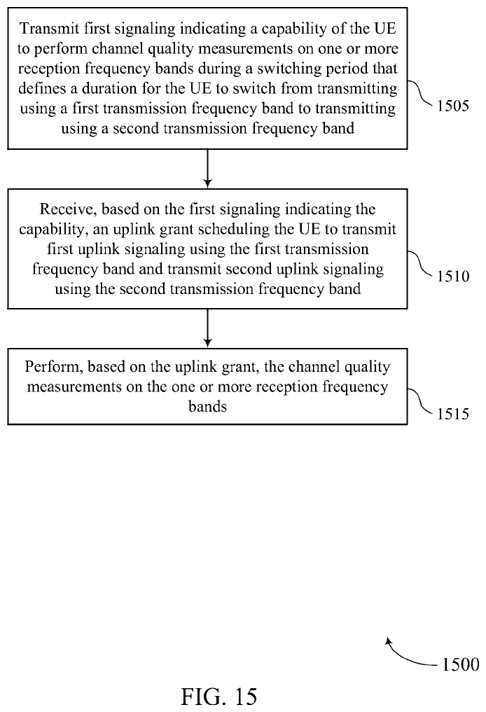

FIG. 15 shows a flowchart illustrating a method 1500 that supports collision rules for measurement gaps in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting first signaling indicating a capability of the UE to perform channel quality measurements on one or more reception frequency bands during a switching period that defines a duration for the UE to switch from transmitting using a first transmission frequency band to transmitting using a second transmission frequency band. The operations of block 1505 may be performed in accordance with examples as disclosed herein. In some examples, aspects of the operations of 1505 may be performed by a UE capability component 925 as described with reference to FIG. 9.

At 1510, the method may include receiving, based on the first signaling indicating the capability, an uplink grant scheduling the UE to transmit first uplink signaling using the first transmission frequency band and transmit second uplink signaling using the second transmission frequency band. The operations of block 1510 may be performed in accordance with examples as disclosed herein. In some examples, aspects of the operations of 1510 may be performed by a UE grant component 930 as described with reference to FIG. 9.

At 1515, the method may include performing, based on the uplink grant, the channel quality measurements on the one or more reception frequency bands. The operations of block 1515 may be performed in accordance with examples as disclosed herein. In some examples, aspects of the operations of 1515 may be performed by a measurement component 935 as described with reference to FIG. 9.

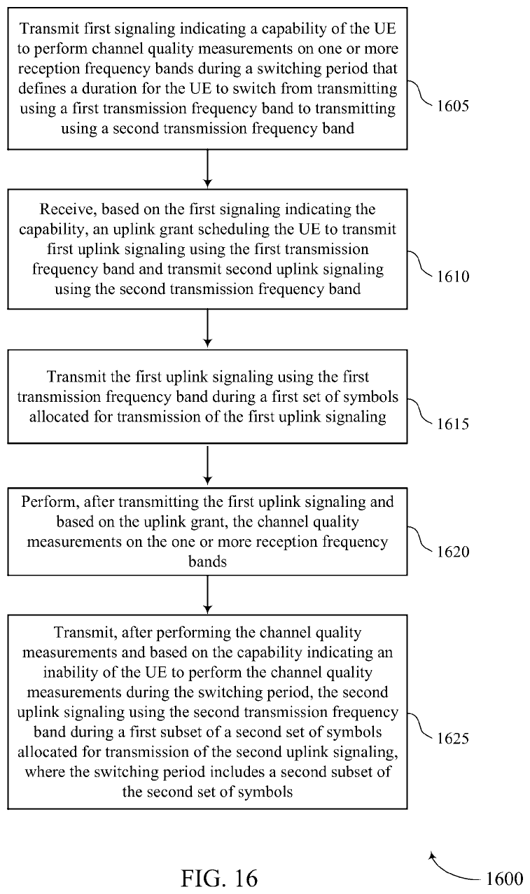

FIG. 16 shows a flowchart illustrating a method 1600 that supports collision rules for measurement gaps in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting first signaling indicating a capability of the UE to perform channel quality measurements on one or more reception frequency bands during a switching period that defines a duration for the UE to switch from transmitting using a first transmission frequency band to transmitting using a second transmission frequency band. The operations of block 1605 may be performed in accordance with examples as disclosed herein. In some examples, aspects of the operations of 1605 may be performed by a UE capability component 925 as described with reference to FIG. 9.

At 1610, the method may include receiving, based on the first signaling indicating the capability, an uplink grant scheduling the UE to transmit first uplink signaling using the first transmission frequency band and transmit second uplink signaling using the second transmission frequency band. The operations of block 1610 may be performed in accordance with examples as disclosed herein. In some examples, aspects of the operations of 1610 may be performed by a UE grant component 930 as described with reference to FIG. 9.

At 1615, the method may include transmitting the first uplink signaling using the first transmission frequency band during a first set of symbols allocated for transmission of the first uplink signaling. The operations of block 1615 may be performed in accordance with examples as disclosed herein. In some examples, aspects of the operations of 1615 may be performed by a signal transmitter 940 as described with reference to FIG. 9.

At 1620, the method may include performing, after transmitting the first uplink signaling and based on the uplink grant, the channel quality measurements on the one or more reception frequency bands. The operations of block 1620 may be performed in accordance with examples as disclosed herein. In some examples, aspects of the operations of 1620 may be performed by a measurement component 935 as described with reference to FIG. 9.

At 1625, the method may include transmitting, after performing the channel quality measurements and based on the capability indicating an inability of the UE to perform the channel quality measurements during the switching period, the second uplink signaling using the second transmission frequency band during a first subset of a second set of symbols allocated for transmission of the second uplink signaling, where the switching period includes a second subset of the second set of symbols. The operations of block 1625 may be performed in accordance with examples as disclosed herein. In some examples, aspects of the operations of 1625 may be performed by a signal transmitter 940 as described with reference to FIG. 9.

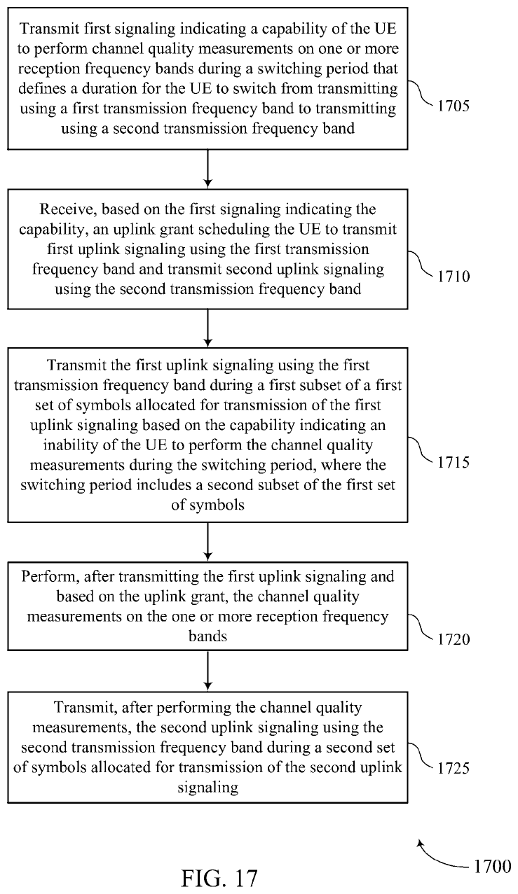

FIG. 17 shows a flowchart illustrating a method 1700 that supports collision rules for measurement gaps in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting first signaling indicating a capability of the UE to perform channel quality measurements on one or more reception frequency bands during a switching period that defines a duration for the UE to switch from transmitting using a first transmission frequency band to transmitting using a second transmission frequency band. The operations of block 1705 may be performed in accordance with examples as disclosed herein. In some examples, aspects of the operations of 1705 may be performed by a UE capability component 925 as described with reference to FIG. 9.

At 1710, the method may include receiving, based on the first signaling indicating the capability, an uplink grant scheduling the UE to transmit first uplink signaling using the first transmission frequency band and transmit second uplink signaling using the second transmission frequency band. The operations of block 1710 may be performed in accordance with examples as disclosed herein. In some examples, aspects of the operations of 1710 may be performed by a UE grant component 930 as described with reference to FIG. 9.

At 1715, the method may include transmitting the first uplink signaling using the first transmission frequency band during a first subset of a first set of symbols allocated for transmission of the first uplink signaling based on the capability indicating an inability of the UE to perform the channel quality measurements during the switching period, where the switching period includes a second subset of the first set of symbols. The operations of block 1715 may be performed in accordance with examples as disclosed herein. In some examples, aspects of the operations of 1715 may be performed by a signal transmitter 940 as described with reference to FIG. 9.

At 1720, the method may include performing, after transmitting the first uplink signaling and based on the uplink grant, the channel quality measurements on the one or more reception frequency bands. The operations of block 1720 may be performed in accordance with examples as disclosed herein. In some examples, aspects of the operations of 1720 may be performed by a measurement component 935 as described with reference to FIG. 9.

At 1725, the method may include transmitting, after performing the channel quality measurements, the second uplink signaling using the second transmission frequency band during a second set of symbols allocated for transmission of the second uplink signaling. The operations of block 1725 may be performed in accordance with examples as disclosed herein. In some examples, aspects of the operations of 1725 may be performed by a signal transmitter 940 as described with reference to FIG. 9.

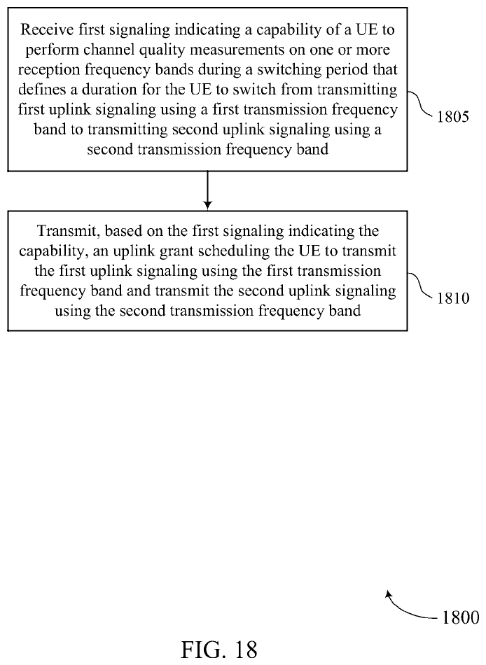

FIG. 18 shows a flowchart illustrating a method 1800 that supports collision rules for measurement gaps in accordance with aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band. The operations of block 1805 may be performed in accordance with examples as disclosed herein. In some examples, aspects of the operations of 1805 may be performed by a capability component 1325 as described with reference to FIG. 13.

At 1810, the method may include transmitting, based on the first signaling indicating the capability, an uplink grant scheduling the UE to transmit the first uplink signaling using the first transmission frequency band and transmit the second uplink signaling using the second transmission frequency band. The operations of block 1810 may be performed in accordance with examples as disclosed herein. In some examples, aspects of the operations of 1810 may be performed by a grant component 1330 as described with reference to FIG. 13.

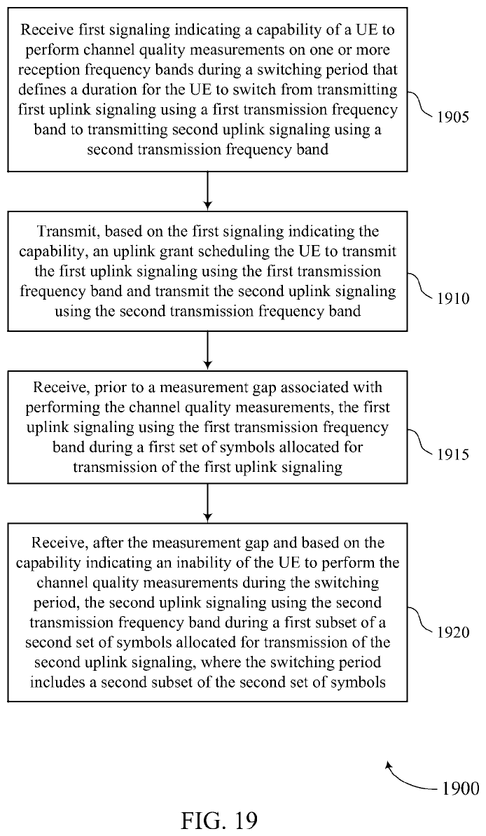

FIG. 19 shows a flowchart illustrating a method 1900 that supports collision rules for measurement gaps in accordance with aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band. The operations of block 1905 may be performed in accordance with examples as disclosed herein. In some examples, aspects of the operations of 1905 may be performed by a capability component 1325 as described with reference to FIG. 13.

At 1910, the method may include transmitting, based on the first signaling indicating the capability, an uplink grant scheduling the UE to transmit the first uplink signaling using the first transmission frequency band and transmit the second uplink signaling using the second transmission frequency band. The operations of block 1910 may be performed in accordance with examples as disclosed herein. In some examples, aspects of the operations of 1910 may be performed by a grant component 1330 as described with reference to FIG. 13.

At 1915, the method may include receiving, prior to a measurement gap associated with performing the channel quality measurements, the first uplink signaling using the first transmission frequency band during a first set of symbols allocated for transmission of the first uplink signaling. The operations of block 1915 may be performed in accordance with examples as disclosed herein. In some examples, aspects of the operations of 1915 may be performed by a signal receiver 1335 as described with reference to FIG. 13.

At 1920, the method may include receiving, after the measurement gap and based on the capability indicating an inability of the UE to perform the channel quality measurements during the switching period, the second uplink signaling using the second transmission frequency band during a first subset of a second set of symbols allocated for transmission of the second uplink signaling, where the switching period includes a second subset of the second set of symbols. The operations of block 1920 may be performed in accordance with examples as disclosed herein. In some examples, aspects of the operations of 1920 may be performed by a signal receiver 1335 as described with reference to FIG. 13.

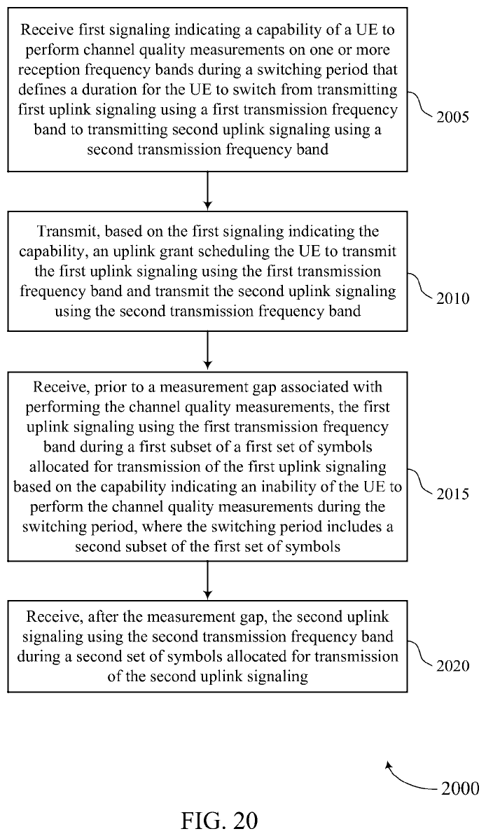

FIG. 20 shows a flowchart illustrating a method 2000 that supports collision rules for measurement gaps in accordance with aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band. The operations of block 2005 may be performed in accordance with examples as disclosed herein. In some examples, aspects of the operations of 2005 may be performed by a capability component 1325 as described with reference to FIG. 13.

At 2010, the method may include transmitting, based on the first signaling indicating the capability, an uplink grant scheduling the UE to transmit the first uplink signaling using the first transmission frequency band and transmit the second uplink signaling using the second transmission frequency band. The operations of block 2010 may be performed in accordance with examples as disclosed herein. In some examples, aspects of the operations of 2010 may be performed by a grant component 1330 as described with reference to FIG. 13.

At 2015, the method may include receiving, prior to a measurement gap associated with performing the channel quality measurements, the first uplink signaling using the first transmission frequency band during a first subset of a first set of symbols allocated for transmission of the first uplink signaling based on the capability indicating an inability of the UE to perform the channel quality measurements during the switching period, where the switching period includes a second subset of the first set of symbols. The operations of block 2015 may be performed in accordance with examples as disclosed herein. In some examples, aspects of the operations of 2015 may be performed by a signal receiver 1335 as described with reference to FIG. 13.

At 2020, the method may include receiving, after the measurement gap, the second uplink signaling using the second transmission frequency band during a second set of symbols allocated for transmission of the second uplink signaling. The operations of block 2020 may be performed in accordance with examples as disclosed herein. In some examples, aspects of the operations of 2020 may be performed by a signal receiver 1335 as described with reference to FIG. 13.

The following provides an overview of aspects of the present disclosure:

Aspect 1: A method for wireless communications at a UE, comprising: transmitting first signaling indicating a capability of the UE to perform channel quality measurements on one or more reception frequency bands during a switching period that defines a duration for the UE to switch from transmitting using a first transmission frequency band to transmitting using a second transmission frequency band; receiving, based at least in part on the first signaling indicating the capability, an uplink grant scheduling the UE to transmit first uplink signaling using the first transmission frequency band and transmit second uplink signaling using the second transmission frequency band; and performing, based at least in part on the uplink grant, the channel quality measurements on the one or more reception frequency bands.

Aspect 2: The method of aspect 1, wherein the uplink grant indicates a first set of symbols allocated for transmission of the first uplink signaling and a second set of symbols allocated for transmission of the second uplink signaling, the first set of symbols associated with an earlier time slot than a time slot associated with the second set of symbols.

Aspect 3: The method of aspect 2, further comprising: transmitting, prior to performing the channel quality measurements, the first uplink signaling using the first transmission frequency band during the first set of symbols; and transmitting, after performing the channel quality measurements and based at least in part on the capability indicating an inability of the UE to perform the channel quality measurements during the switching period, the second uplink signaling using the second transmission frequency band during a first subset of the second set of symbols, wherein the switching period comprises a second subset of the second set of symbols.

Aspect 4: The method of any of aspects 2 through 3, further comprising: transmitting, prior to performing the channel quality measurements, the first uplink signaling using the first transmission frequency band during a first subset of the first set of symbols based at least in part on the capability indicating an inability of the UE to perform the channel quality measurements during the switching period, wherein the switching period comprises a second subset of the first set of symbols; and transmitting, after performing the channel quality measurements, the second uplink signaling using the second transmission frequency band during the second set of symbols.

Aspect 5: The method of any of aspects 2 through 4, further comprising: refraining from transmitting one or both of the first uplink signaling or the second uplink signaling based at least in part on the capability indicating an inability of the UE to perform the channel quality measurements during the switching period, wherein the switching period comprises at least a subset of the first set of symbols or the second set of symbols.

Aspect 6: The method of any of aspects 2 through 5, wherein performing the channel quality measurements comprises: performing the channel quality measurements a first gap period after the switching period based at least in part on the capability indicating an inability of the UE to perform the channel quality measurements during the switching period, wherein the switching period occurs after a last symbol of the first set of symbols.

Aspect 7: The method of aspect 6, further comprising: transmitting second signaling indicating a set of gap periods comprising the first gap period, wherein the uplink grant is based at least in part on the set of gap periods.

Aspect 8: The method of any of aspects 2 through 7, further comprising: transmitting the second uplink signaling after the switching period based at least in part on the capability indicating an inability of the UE to perform the channel quality measurements during the switching period, wherein the switching period occurs a first gap period after performing the channel quality measurements.

Aspect 9: The method of aspect 8, further comprising: transmitting second signaling indicating one or more gap periods comprising the first gap period, wherein the uplink grant is based at least in part on the one or more gap periods.

Aspect 10: The method of any of aspects 1 through 9, wherein performing the channel quality measurements comprises: performing the channel quality measurements during at least a portion of the switching period based at least in part on the capability indicating an ability of the UE to perform the channel quality measurements during the switching period.

Aspect 11: A method for wireless communication at a network entity, comprising: receiving first signaling indicating a capability of a UE to perform channel quality measurements on one or more reception frequency bands during a switching period that defines a duration for the UE to switch from transmitting first uplink signaling using a first transmission frequency band to transmitting second uplink signaling using a second transmission frequency band; and transmitting, based at least in part on the first signaling indicating the capability, an uplink grant scheduling the UE to transmit the first uplink signaling using the first transmission frequency band and transmit the second uplink signaling using the second transmission frequency band.

Aspect 12: The method of aspect 11, wherein the uplink grant indicates a first set of symbols allocated for transmission of the first uplink signaling and a second set of symbols allocated for transmission of the second uplink signaling, the first set of symbols associated with an earlier time slot than a time slot associated with the second set of symbols.

Aspect 13: The method of aspect 12, further comprising: receiving, prior to a measurement gap associated with performing the channel quality measurements, the first uplink signaling using the first transmission frequency band during the first set of symbols; and receiving, after the measurement gap and based at least in part on the capability indicating an inability of the UE to perform the channel quality measurements during the switching period, the second uplink signaling using the second transmission frequency band during a first subset of the second set of symbols, wherein the switching period comprises a second subset of the second set of symbols.

Aspect 14: The method of any of aspects 12 through 13, further comprising: receiving, prior to a measurement gap associated with performing the channel quality measurements, the first uplink signaling using the first transmission frequency band during a first subset of the first set of symbols based at least in part on the capability indicating an inability of the UE to perform the channel quality measurements during the switching period, wherein the switching period comprises a second subset of the first set of symbols; and receiving, after the measurement gap, the second uplink signaling using the second transmission frequency band during the second set of symbols.

Aspect 15: The method of any of aspects 12 through 14, wherein the uplink grant further indicates that a last symbol of the first set of symbols occurs prior to the switching period and a measurement gap associated with performing the channel quality measurements occurs a first gap period after the switching period.

Aspect 16: The method of aspect 15, further comprising: receiving second signaling indicating a set of gap periods comprising the first gap period, wherein the uplink grant is based at least in part on the set of gap periods.

Aspect 17: The method of any of aspects 12 through 16, wherein the uplink grant further indicates that the switching period occurs prior to a first symbol of the second set of symbols and a measurement gap associated with performing the channel quality measurements ends a first gap period prior to the switching period.

Aspect 18: The method of aspect 17, further comprising: receiving second signaling indicating a set of gap periods comprising the first gap period, wherein the uplink grant is based at least in part on the set of gap periods.

Aspect 19: A UE for wireless communications, comprising one or more memories storing processor-executable code, and one or more processors coupled with the one or more memories and individually or collectively operable to execute the code to cause the UE to perform a method of any of aspects 1 through 10.

Aspect 20: A UE for wireless communications, comprising at least one means for performing a method of any of aspects 1 through 10.

Aspect 21: A non-transitory computer-readable medium storing code for wireless communications, the code comprising instructions executable by a processor to perform a method of any of aspects 1 through 10.

Aspect 22: A network entity for wireless communication, comprising one or more memories storing processor-executable code, and one or more processors coupled with the one or more memories and individually or collectively operable to execute the code to cause the network entity to perform a method of any of aspects 11 through 18.

Aspect 23: A network entity for wireless communication, comprising at least one means for performing a method of any of aspects 11 through 18.

Aspect 24: A non-transitory computer-readable medium storing code for wireless communication, the code comprising instructions executable by a processor to perform a method of any of aspects 11 through 18.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
one or more memories storing processor-executable code; and
one or more processors coupled with the one or more memories and individually or collectively operable to execute the code to cause the UE to:
transmit first signaling indicating a capability of the UE to perform channel quality measurements on one or more reception frequency bands during a switching period that defines a duration for the UE to switch from transmitting using a first transmission frequency band to transmitting using a second transmission frequency band;
receive, based at least in part on the first signaling indicating the capability, an uplink grant scheduling the UE to transmit first uplink signaling using the first transmission frequency band and transmit second uplink signaling using the second transmission frequency band; and
perform, based at least in part on the uplink grant, the channel quality measurements on the one or more reception frequency bands.

2. The UE of claim 1, wherein the uplink grant indicates a first set of symbols allocated for transmission of the first uplink signaling and a second set of symbols allocated for transmission of the second uplink signaling, the first set of symbols associated with an earlier time slot than a time slot associated with the second set of symbols.

3. The UE of claim 2, wherein the one or more processors are individually or collectively further operable to execute the code to cause the UE to:
transmit, prior to performing the channel quality measurements, the first uplink signaling using the first transmission frequency band during the first set of symbols; and
transmit, after performing the channel quality measurements and based at least in part on the capability indicating an inability of the UE to perform the channel quality measurements during the switching period, the second uplink signaling using the second transmission frequency band during a first subset of the second set of symbols, wherein the switching period comprises a second subset of the second set of symbols.

4. The UE of claim 2, wherein the one or more processors are individually or collectively further operable to execute the code to cause the UE to:
transmit, prior to performing the channel quality measurements, the first uplink signaling using the first transmission frequency band during a first subset of the first set of symbols based at least in part on the capability indicating an inability of the UE to perform the channel quality measurements during the switching period, wherein the switching period comprises a second subset of the first set of symbols; and
transmit, after performing the channel quality measurements, the second uplink signaling using the second transmission frequency band during the second set of symbols.

5. The UE of claim 2, wherein the one or more processors are individually or collectively further operable to execute the code to cause the UE to:
refrain from transmitting one or both of the first uplink signaling or the second uplink signaling based at least in part on the capability indicating an inability of the UE to perform the channel quality measurements during the switching period, wherein the switching period comprises at least a subset of the first set of symbols or the second set of symbols.

6. The UE of claim 2, wherein, to perform the channel quality measurements, the one or more processors are individually or collectively operable to execute the code to cause the UE to:
perform the channel quality measurements a first gap period after the switching period based at least in part on the capability indicating an inability of the UE to perform the channel quality measurements during the switching period, wherein the switching period occurs after a last symbol of the first set of symbols.

7. The UE of claim 6, wherein the one or more processors are individually or collectively further operable to execute the code to cause the UE to:
transmit second signaling indicating a set of gap periods comprising the first gap period, wherein the uplink grant is based at least in part on the set of gap periods.

8. The UE of claim 2, wherein the one or more processors are individually or collectively further operable to execute the code to cause the UE to:
transmit the second uplink signaling after the switching period based at least in part on the capability indicating an inability of the UE to perform the channel quality measurements during the switching period, wherein the switching period occurs a first gap period after performing the channel quality measurements.

9. The UE of claim 8, wherein the one or more processors are individually or collectively further operable to execute the code to cause the UE to:
transmit second signaling indicating one or more gap periods comprising the first gap period, wherein the uplink grant is based at least in part on the one or more gap periods.

10. The UE of claim 1, wherein, to perform the channel quality measurements, the one or more processors are individually or collectively operable to execute the code to cause the UE to:
perform the channel quality measurements during at least a portion of the switching period based at least in part on the capability indicating an ability of the UE to perform the channel quality measurements during the switching period.

11. A network entity, comprising:
one or more memories storing processor-executable code; and
one or more processors coupled with the one or more memories and individually or collectively operable to execute the code to cause the network entity to:
receive first signaling indicating a capability of a user equipment (UE) to perform channel quality measurements on one or more reception frequency bands during a switching period that defines a duration for the UE to switch from transmitting first uplink signaling using a first transmission frequency band to transmitting second uplink signaling using a second transmission frequency band; and
transmit, based at least in part on the first signaling indicating the capability, an uplink grant scheduling the UE to transmit the first uplink signaling using the first transmission frequency band and transmit the second uplink signaling using the second transmission frequency band.

12. The network entity of claim 11, wherein the uplink grant indicates a first set of symbols allocated for transmission of the first uplink signaling and a second set of symbols allocated for transmission of the second uplink signaling, the first set of symbols associated with an earlier time slot than a time slot associated with the second set of symbols.

13. The network entity of claim 12, wherein the one or more processors are individually or collectively further operable to execute the code to cause the network entity to:
receive, prior to a measurement gap associated with performing the channel quality measurements, the first uplink signaling using the first transmission frequency band during the first set of symbols; and
receive, after the measurement gap and based at least in part on the capability indicating an inability of the UE to perform the channel quality measurements during the switching period, the second uplink signaling using the second transmission frequency band during a first subset of the second set of symbols, wherein the switching period comprises a second subset of the second set of symbols.

14. The network entity of claim 12, wherein the one or more processors are individually or collectively further operable to execute the code to cause the network entity to:
receive, prior to a measurement gap associated with performing the channel quality measurements, the first uplink signaling using the first transmission frequency band during a first subset of the first set of symbols based at least in part on the capability indicating an inability of the UE to perform the channel quality measurements during the switching period, wherein the switching period comprises a second subset of the first set of symbols; and
receive, after the measurement gap, the second uplink signaling using the second transmission frequency band during the second set of symbols.

15. The network entity of claim 12, wherein the uplink grant further indicates that a last symbol of the first set of symbols occurs prior to the switching period and a measurement gap associated with performing the channel quality measurements occurs a first gap period after the switching period.

16. The network entity of claim 15, wherein the one or more processors are individually or collectively further operable to execute the code to cause the network entity to:
receive second signaling indicating a set of gap periods comprising the first gap period, wherein the uplink grant is based at least in part on the set of gap periods.

17. The network entity of claim 12, wherein the uplink grant further indicates that the switching period occurs prior to a first symbol of the second set of symbols and a measurement gap associated with performing the channel quality measurements ends a first gap period prior to the switching period.

18. The network entity of claim 17, wherein the one or more processors are individually or collectively further operable to execute the code to cause the network entity to:
receive second signaling indicating a set of gap periods comprising the first gap period, wherein the uplink grant is based at least in part on the set of gap periods.

19. A method for wireless communications at a user equipment (UE), comprising:
transmitting first signaling indicating a capability of the UE to perform channel quality measurements on one or more reception frequency bands during a switching period that defines a duration for the UE to switch from transmitting using a first transmission frequency band to transmitting using a second transmission frequency band;
receiving, based at least in part on the first signaling indicating the capability, an uplink grant scheduling the UE to transmit first uplink signaling using the first transmission frequency band and transmit second uplink signaling using the second transmission frequency band; and
performing, based at least in part on the uplink grant, the channel quality measurements on the one or more reception frequency bands.

20. The method of claim 19, wherein the uplink grant indicates a first set of symbols allocated for transmission of the first uplink signaling and a second set of symbols allocated for transmission of the second uplink signaling, the first set of symbols associated with an earlier time slot than a time slot associated with the second set of symbols.

21-30. (canceled)
